(19) United States
(12) Patent Application Publication
(10) Pub. No.: US 2015/0221153 A1
(43) Pub. Date: Aug. 6, 2015

(54) METHODS AND APPARATUS FOR VOTER REGISTRATION AND VOTING USING MOBILE COMMUNICATION DEVICES

(71) Applicant: ICITIZEN CORPORATION, Nashville, TN (US)

(72) Inventors: Duncan DASHIFF, Nashville, TN (US); Rod MASSEY, Franklin, TN (US); Matt URMY, Nashville, TN (US)

(73) Assignee: ICITIZEN CORPORATION, Nashville, TN (US)

(21) Appl. No.: 14/616,426

(22) Filed: Feb. 6, 2015

Related U.S. Application Data
(60) Provisional application No. 61/936,470, filed on Feb. 6, 2014.

(51) Int. Cl. G07C 13/00

(52) U.S. Cl. CPC G07C 13/00

(57) ABSTRACT

Some embodiments described herein relate to an apparatus including a registration module and a vote module. The registration module can generally be operable to register a user device and/or a user. The vote module can generally be operable to receive, validate, and/or tally votes from the user device. The registration module can receive a request for registration including registration identification information. The user of the user device can be authenticated against a voter-authority database. An authentication code for validating the user device can also be received or assigned. After registration, the vote module can receive a signal representing a vote from the user device and identification information. The user device can be validated by receiving the authentication code. The user of the user device (i.e., the voter) can be validated by receiving voting identification information and matching the voter identification information to the registration identification information.

### CROSS REFERENCE TO RELATED APPLICATIONS

This application claims the benefit of provisional U.S. Patent Application No. 61/936,470, filed Feb. 6, 2014, under 35 U.S.C. §119(e), the disclosure of which is hereby incorporated by reference in its entirety.

### BACKGROUND

Some embodiments described herein relate generally to methods and apparatus for authentication of voter registration in mobile communication devices and implementing voting using mobile communication devices.

Recently, the US voting system has implemented the “vote-by-mail” system, whereby a paper ballot is mailed to the home of a registered voter, and the voter fills out the paper ballot and returns the completed ballot paper via United States Postal Service (USPS) to a local county or state voting agency. The “vote-by-mail” system according to some estimates, now accounts for approximately 20% of all ballots cast, and is of benefit to people who may not be able to attend a polling station in person, either through a physical disability or due to a polling center being absent from the locality. Additionally, the “vote-by-mail” system can eliminate the need to staff and run a polling center during an election, and can result in considerable cost savings to a state. Balloting materials may be sent via USPS without prepayment of postage. The “vote-by-mail” system, however, has raised concerns as to whether it complies with the requirements of a secret ballot, because people cast their vote outside the security of a polling station, and whether voters can cast their vote privately free from third party coercion. Additionally, the “vote-by-mail” system can also introduce problems associated with the operational efficiency of local USPS offices.

Accordingly, a need exists for methods and apparatus for implementing a voter registration system in mobile communication devices of voters that can authenticate the voter registration of a legitimate voter and can be used to cast votes.

### SUMMARY

Some embodiments described herein relate to an apparatus including a registration module and a vote module. The registration module can generally be operable, for example, to register a user device and/or a user. The vote module can generally be operable, for example, to receive, validate, and/or tally votes from the user device.

During registration, the registration module can receive a request for registration including registration identification information. The registration identification information can include one or more of a possession factor, a knowledge factor, an inherence factor, or an indication of approval from a pre-authorized registration agent. The registration module can internally register the user by storing the registration identification information, externally register the user by providing the registration identification information to a voter authority, and/or validate the user by comparing the registration identification information against a voter-authority database. Also during registration, an authentication code for validating the user device can be received or assigned, for example, after authenticating the user. The authentication code can be sent to the user device and can be operable to uniquely identify the user device.

After registration, the vote module can receive a signal representing a vote from the user device and vote identification information. The user device can be validated by receiving the authentication code, which may be included with the vote identification information. Similarly stated, the authentication code can be effective to uniquely identify the user device, such that when the authentication device is received, the vote module can verify that the user device is the same user device as sent the registration information. The user of the user device (i.e., the voter) can be validated by receiving vote identification information, which can include one or more of a possession factor, a knowledge factor, an inherence factor, or an indication of approval from a pre-authorized poll worker. The vote identification information can be matched against the registration identification information and/or the voter authority database. The vote module can be operable to tally the vote when the user and the user device are each validated.

### BRIEF DESCRIPTION OF THE DRAWINGS

FIG. 1 is a schematic illustration of a system for registration of voters and/or communication devices, according to an embodiment.

FIG. 2 is a message flow diagram illustrating a process for registration of voters and/or communication devices, according to an embodiment.

FIG. 3 is a schematic illustration of a system for casting votes using communication devices, according to an embodiment

FIG. 4 is a message flow diagram illustrating a process for voting using communication devices, according to an embodiment.

### DETAILED DESCRIPTION

In some embodiments, an apparatus includes a voter registration application and a validation module that can be used to authenticate and register a legitimate voter and/or a communication device. The validation module can be operable to obtain identification information uniquely associated with the voter and/or can register the user to vote. The validation module can also be operable to receive and/or assign an authentication code uniquely identifying the communication device. The apparatus can be used by authenticated voters to cast private electronically votes using virtual ballots.

As used herein, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

As used in this specification, the singular forms “a,” “an” and “the” include plural referents unless the context clearly dictates otherwise. Thus, for example, the term “a communication device” is intended to mean a single communication device or a combination of communication devices.

Some embodiments described herein relate to an apparatus including a registration module and a vote module. The registration module can generally be operable, for example, to register a user device and/or a user. The vote module can generally be operable, for example, to receive, validate, and/or tally votes from the user device.

During registration, the registration module can receive a request for registration including registration identification information. The registration identification information can include one or more of a possession factor, a knowledge factor, an inherence factor, or an indication of approval from a pre-authorized registration agent. The registration module can internally register the user by storing the registration identification information, externally register the user by providing the registration identification information to a voter authority, and/or validate the user by comparing the registration identification information against a voter-authority database. Also during registration, an authentication code for validating the user device can be received or assigned, for example, after authenticating the user. The authentication code can be sent to the user device and can be operable to uniquely identify the user device.

After registration, the vote module can receive a signal representing a vote from the user device and vote identification information. The user device can be validated by receiving the authentication code, which may be included with the vote identification information. Similarly stated, the authentication code can be effective to uniquely identify the user device, such that when the authentication device is received, the vote module can verify that the user device is the same user device as sent the registration information. The user of the user device (i.e., the voter) can be validated by receiving vote identification information, which can include one or more of a possession factor, a knowledge factor, an inherence factor, or an indication of approval from a pre-authorized poll worker. The vote identification information can be matched against the registration identification information and/or the voter authority database. The vote module can be operable to tally the vote when the user and the user device are each validated.

Some embodiments described herein relate to an apparatus including a validation module, a network module, and a ballot module. The validation module can generally be operable to obtain possession factor(s) and/or inherence factor(s) associated with the user of the apparatus. The network module can be operable to send information to a registration identification information to a registration server. The registration identification information can include one or more of a possession factor (e.g., obtained from the validation module during a registration time period), a knowledge factor, an inherence factor (e.g., obtained from the validation module during a registration time period), an indication of approval from a pre-authorized registration agent, or any other suitable identification information.

The ballot module can be operable to obtain voter identification information, for example, by causing the validation module to obtain the possession factor and/or the inherence factor during a voting time period, which can occur after the registration time period. The ballot module can also be operable to obtain any other suitable identification information, such as a knowledge factor or an indication of approval from a pre-authorized poll worker via any suitable module, such as an input/output module and/or device (e.g., a keyboard/monitor, touchscreen, etc.). The ballot module can be operable to allow a user of the apparatus to cast a vote. For example, the ballot module can be operable to receive a representation of a ballot and an authentication code, for example, in response to the network module sending the registration information. The ballot module can then send a representation of a selection of at least one question on the ballot. The ballot module can also send the authentication code and the voter identification information such that a voting server tallies the selection of the question on the ballot when the possession factor or the inherency factor (or any other suitable identification information) obtained during the voting time period matches information stored in a registration database and when the sent authentication code matches the received authentication code.

Some embodiments described herein relate to a method that includes receiving a request to register a user device including registration identification information collected during a registration time period. The registration identification information can include one or more of a possession factor, a knowledge factor, an inherence factor, an indication of approval from a pre-authorized registration agent, or any other suitable identification information. The user of the user device (a voter) can be validated and the user device can be associated with a voter registration number based on the registration identification information matching an entry in a voter registration database. Once the voter is validated, a ballot can be sent to the user device and an indication of a vote (e.g., a selection of question on the ballot) can be received, for example from the user device. The indication of the vote can include a voter registration number and vote identification information collected during a voting time period, which can occur after the registration time period. The vote identification information can include a possession factor, an inherence factor, a knowledge factor, an indication of approval from a pre-authorized poll worker, or any other suitable identification information. The vote can be tallied when the vote identification information matches the registration identification information and when the voter registration number received with the vote matches the voter registration number associated with the user device.

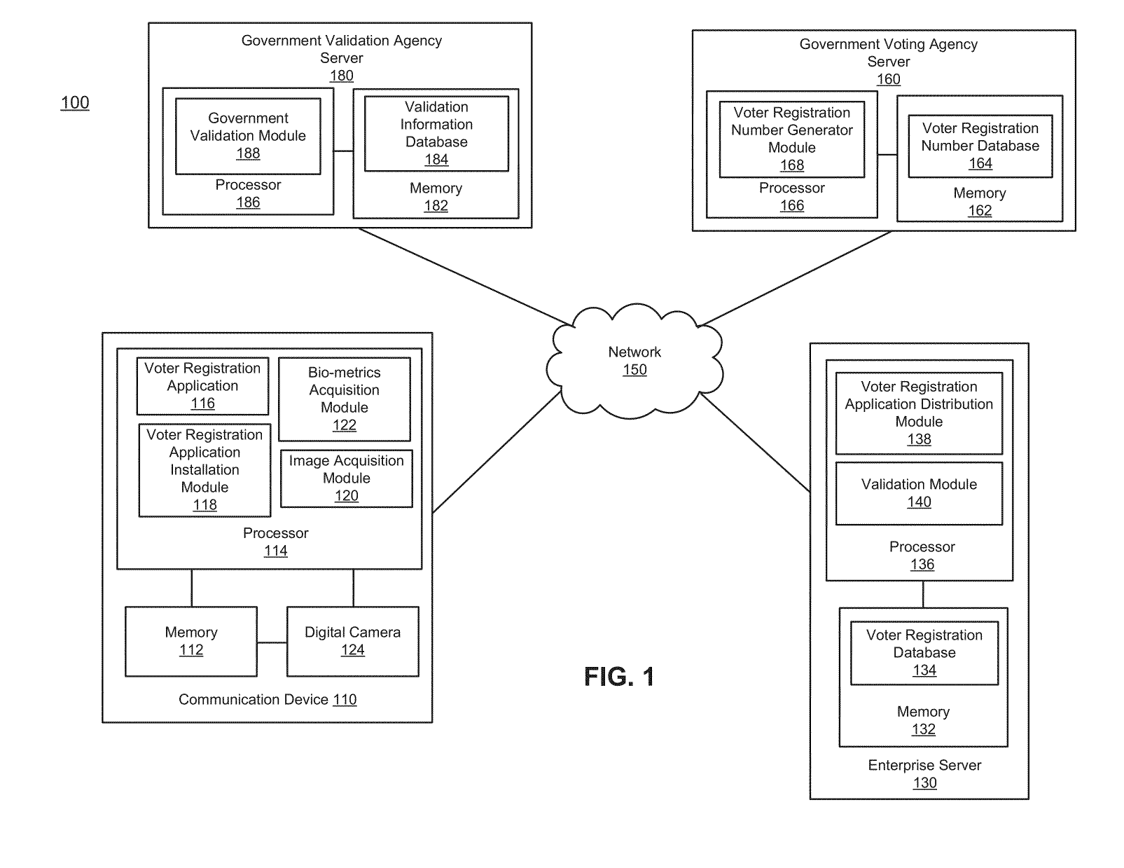

FIG. 1 is a schematic illustration of a system for internally and/or externally registering voters and/or voters' communication devices, according to an embodiment. The system 100 shown in FIG. 1 includes a communication device 110, an enterprise server 130, a network 150, a government voting agency server 160, and a government validation agency server 180. The communication device 110 can be any suitable compute device, such as, for example, a laptop computer, a desktop computer, a tablet computer, a mobile telephone, a smartphone, a personal digital assistant (PDA), a video game console, and/or so forth.

The network 150 can be any type of network (e.g., a local area network (LAN), a wide area network (WAN), a virtual network, and a telecommunications network) implemented as a wired network and/or a wireless network. As described in further detail herein, in some configurations, for example, the communication device 110 can be connected to the enterprise server 130 and/or the government voting agency server 160 and/or the government validation agency server 180 via network 150 that can include an intranet, an Internet Service Provider (ISP) and the Internet, a cellular network (e.g., network 150), and/or the like.

The communication device 110 includes a memory 112 and a processor 114. The memory 112 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 112 can store instructions to cause the processor 114 to execute modules, processes and/or functions associated with the communication device 110 and the voter registration system 100. The processor 114 can be a general purpose processor, a Field Programmable Gate Array (FPGA), an Application Specific Integrated Circuit (ASIC), a Digital Signal Processor (DSP), and/or the like. The processor 114 can run and/or execute applications, modules, processes and/or functions associated with the communication device 110 and/or the voter registration system 100. The processor 114 includes a voter registration application 116, a voter registration application installation module 118, an image acquisition module 120, and optionally (as denoted by the dashed box) a biometrics acquisition module 122.

As described in further detail herein, the communication device 110 can be used to register users to participate in an election and/or cast a ballot in an election, opinion poll, or any voting exercise. In some embodiments, the communication device 110 can be owned by a private citizen (also referred to herein as a user or a voter). Similarly stated, the communication device 110 may not be provided by a government, corporate entity, advocacy group, or other entity for an election conducted by the entity. As described in further detail herein, in some embodiments, the communication device 110 can be used for in-person or remote bring-your-own-device (BYOD) voter registration and/or in-person or remote BYOD voting. In other embodiments, the communication device 110 may be supplied by the entity for the election conducted by the entity. Furthermore, although a single communication device 110 is shown in FIG. 1, it should be understood that this is for illustrative purposes, and the system 100 can include any number of communication devices. For example, in an election with multiple voters, each voter may bring their own device. Alternatively, multiple voters may use one or more shared communication devices to register and/or vote. Furthermore, in some instances, one voter may use one communication device to register to vote and another communication device to cast a vote.

The voter registration application installation module 118 can be a native application installed on the communication device 110. The voter registration application installation module 118 can be hardware module(s) and/or software module(s) (stored in memory 112 and/or executed in a processor 114) that sends user (i.e., voter) authentication information to the enterprise server 130 such as, for example, a communication device identifier, a picture or photo of the users driver's license or government identification card, any optional biometric information related to the user such as finger print scans, retinal scans, voice data and/or voice print analysis, and/or the like. Upon successful validation of the user, the voter registration application installation module 118 can receive a voter registration application file from the enterprise server 130. Upon receipt of such a voter registration application file, the voter registration application installation module 118 can install the voter registration application file on the communication device 110 to produce the voter registration application 116, and register the voter registration application 116 for an appropriate voter identifier (e.g., a name, a date of birth, driver's license number, government identification card number, etc.). Note that the voter registration application file received from the enterprise server 130 can be an executable file.

The voter registration application 116 can be a hardware module and/or a software module (stored in memory 112 and/or executed in a processor 114). The voter registration application 116 can be installed in the communication device 110 and can validate a legitimate registered voter (e.g., a user of the communication device 110) with the enterprise server 130 and/or the government voting agency server 160 so that the registered voter can cast a vote using the voter registration application 116. The voter registration application 116 can cause the processor 114 to execute specific functions associated with validating a registered voter.

The image acquisition module 120 can interface with and control a digital camera 124 (e.g., Sony DSC-QX10 digital camera) that can be used, for example, to take a photograph of the user of the communication device 110, a photograph of the user's driver's license, the user's government identification card, and/or the like. The communication device 110 can also include a biometrics acquisition module 122 that can interface with and control, for example, a fingerprint sensor (not shown in FIG. 1), a retinal sensor (not shown in FIG. 1), an infrared face profile sensor (not shown in FIG. 1), a microphone (not shown in FIG. 1) and/or the like. The biometrics acquisition module 122 can be used to obtain the above-mentioned biometrics of a user that can be used, at least in part, to validate a legitimate and potential registered voter (a voter can be a user of the communication device 110) in the enterprise server 130 and obtain a virtual voter registration number from the government voting agency server 160.

The enterprise server 130 can be, for example, a web server, an application server, a proxy server, a telnet server, a file transfer protocol (FTP) server, a mail server, a list server, a collaboration server and/or the like. The enterprise server 130 can be, for example, used to send voter registration applications to the mobile communication devices 110 of a set of voters in a particular voting district. Additionally, in some embodiments, the enterprise server 130 can also be used to, for example, register users with a voter authority (such as a government, advocacy group, corporation, or other election-holding body), referred to herein as external voter registration. For example, the enterprise server 130 can be operable to receive data from the communication device 110 conforming to regulations of the voter authority to register a user to vote. In some instances, registering a user to vote can be registering a user to vote with a governmental body such that the enterprise server 130 can be operable to obtain data from the communication device 110 conforming to local and/or national voter registration laws and/or regulations. In response to registering a user with a voter authority, the enterprise server 130, the communication device 110, and/or the voter can be sent a virtual and/or physical (e.g., a printed card sent by mail) registration number or identification.

In some embodiments, the enterprise server 130 can be operable to register voters to vote using the communication device 110 and/or the enterprise server 130 such that when the user and/or the communication device 110 are used to cast a vote, the enterprise server 130 can validate the user and/or the communication device 110 against internal registration data. Such a registration can be in addition to or an alternative to external voter registration and is referred to herein as internal voter registration. Internal voter registration can include registering the user and/or registering the communication device 110. .

The enterprise server 130 includes a memory 132 and a processor 136. The memory 132 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 132 can store instructions to cause the processor 136 to execute modules, processes and/or functions associated with the enterprise server 130 and/or the voter registration system 100. The memory 132 includes voter registration database 134. The voter registration database 134 can be, for example, a look-up table that includes the identifiers (e.g., name, date of birth, gender, a user login, a user password, a personal identification number (PIN), residential address, driver's license number, social security number, and/or etc.) associated with the different legitimate voters (e.g., in a specific voting district, in a county, etc.) that have obtained a voter registration application from the enterprise.

The processor 136 can be a general purpose processor, a Field Programmable Gate Array (FPGA), an Application Specific Integrated Circuit (ASIC), a Digital Signal Processor (DSP), and/or the like. The processor 136 can run and/or execute applications, modules, processes and/or functions associated with the enterprise server 130 and/or the voter registration system 100. The processor 136 includes a voter registration application distribution module 138 and a validation module 140. The voter registration application distribution module 138 can be a hardware module(s) and/or software module(s) (stored in memory 132 and/or executed in processor 136) that can send voter registration application files (e.g., executable files) to different mobile communication devices 110 associated with users that are potential registered voters in a voting district upon validation of the user identification information (i.e., sent by the voter registration application installation module 118). The voter registration application distribution module 138 can send the voter registration application file, for example, as an executable file, via the network 150 to the communication device 110. Such an executable file can then be installed by the voter registration application installation module 118 in the communication device 110.

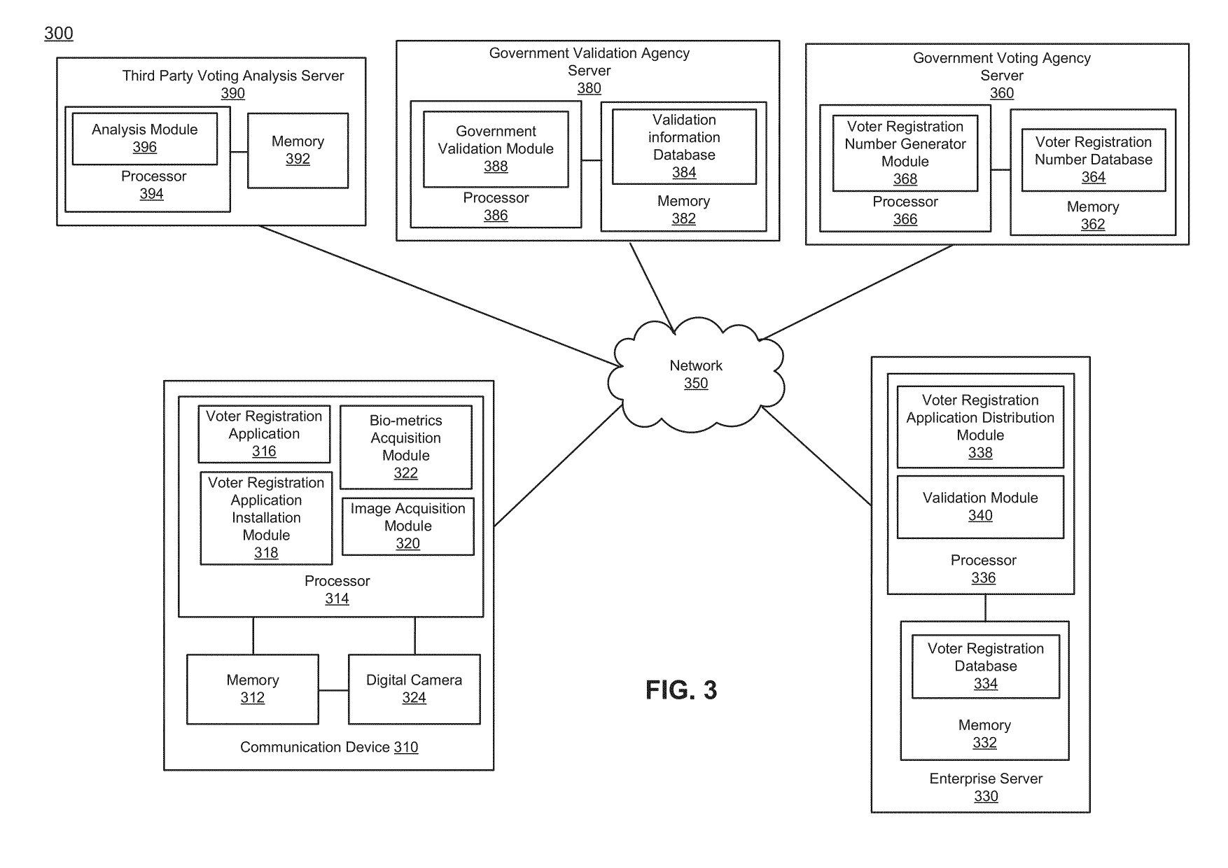

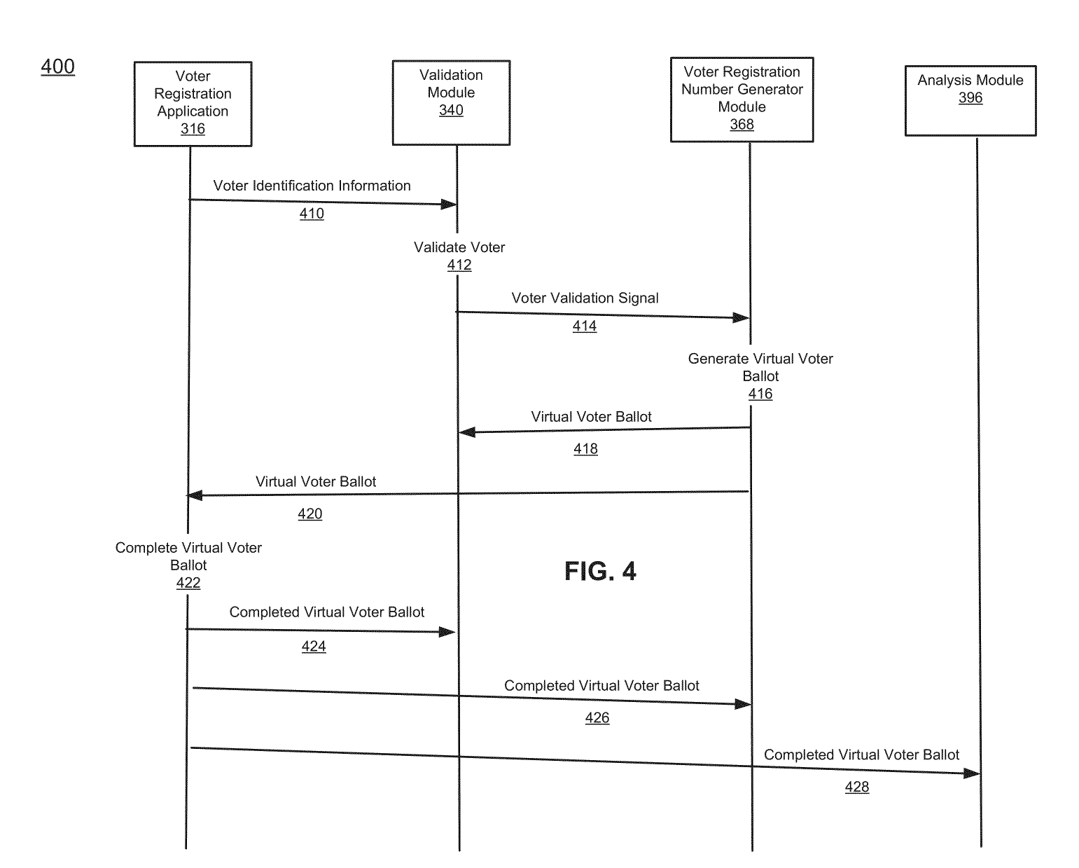

The validation module 140 can be a hardware module(s) and/or software module(s) (stored in memory 132 and/or executed in processor 136) that can validate user identification information associated with a user of a communication device 110 that in some instances, can be a potential registered voter in a specific voting district. Additionally, the validation module 140 can also validate the voter registration information of such a voter with a voter authority, such as the government voting agency server 160 and/or the government validation agency server 180 such that a potential registered voter can receive a virtual voting registration number from the government voting agency server 160, and can subsequently use the virtual voting registration number to cast an accurate vote in an election (as discussed more below in reference to FIGS. 3 and 4).

The government voting agency server 160 can be, for example, a web server, an application server, a proxy server, a telnet server, a file transfer protocol (FTP) server, a mail server, a list server, a collaboration server and/or the like. The government voting agency server 160 can be, for example, a server associated with the US federal government election department, a state government election department, a county election department, or any other national and/or local election authority. The government voting agency server 160 includes a memory 162 and a processor 166. The memory 162 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 162 can store instructions to cause the processor 166 to execute modules, processes and/or functions associated with the government voting agency server 160 and/or the voter registration system 100. The memory 162 can include a voter registration number database 164 that can be look-up table that includes the identifiers (name, date of birth, gender, residential address, driver's license number, etc.) associated with the different voters in, for example, a state, a county, or a specific voting district after each of those voters have been issued with a valid voter registration number (e.g., either a virtual voter registration number and/or a paper-application-based voter registration number).

The processor 166 can be a general purpose processor, a Field Programmable Gate Array (FPGA), an Application Specific Integrated Circuit (ASIC), a Digital Signal Processor (DSP), and/or the like. The processor 166 can run and/or execute applications, modules, processes and/or functions associated with the government voting agency server 160 and/or the voter registration system 100. The processor 166 includes a voter registration number generation module 168 that can be used to generate a virtual voting registration number for a potential, legitimate, and registered voter associated with a communication device 110. In some configurations, the virtual voter registration numbers can be generated by a random number generator and compared with existing voter registration numbers in the voter registration number database 164. In such configurations, if such comparisons do not yield a positive match, the newly-generated virtual voter registration number can be sent to the enterprise server 130 (that sent the voter registration number generation request). In such configurations, if such comparisons do yield a positive match, the voter registration number generation module 168 can discard the newly-generated virtual voter registration number and go through one or more cycles of random number generation until a new, unused, and valid virtual voter registration number can be generated for the particular voter registration number generation request. In such configurations, the voter registration number generation module 168 can store the newly-generated valid voter registration number and the associated identifier of the voter in the voter registration number database 164.

The government validation agency server 180 can be, for example, a web server, an application server, a proxy server, a telnet server, a file transfer protocol (FTP) server, a mail server, a list server, a collaboration server and/or the like. The government validation agency server 180 can be, for example, a server associated with the Department of Motor Vehicles (DMV) in a particular state. The government validation agency server 180 includes a memory 182 and a processor 186. The memory 182 can be, for example, a random access memory (RAM), a memory buffer, a hard drive, a database, an erasable programmable read- only memory (EPROM), an electrically erasable read-only memory (EEPROM), a read-only memory (ROM) and/or so forth. The memory 182 can store instructions to cause the processor 186 to execute modules, processes and/or functions associated with the government validation agency server 180 and/or the voter registration system 100. The memory 182 includes a validation information database 184 that can be look-up table that includes the identifiers (name, date of birth, gender, residential address, driver's license number, voter registration number, social security number, passport number, etc.) associated with a population (e.g., both legitimate voters and non-voters such as underage US citizens, felons, permanent resident aliens, non-permanent resident aliens, etc.) in, for example, a state, a county, or a specific voting district.

The processor 186 can be a general purpose processor, a Field Programmable Gate Array (FPGA), an Application Specific Integrated Circuit (ASIC), a Digital Signal Processor (DSP), and/or the like. The processor 186 can run and/or execute applications, modules, processes and/or functions associated with the government validation agency server 180 and/or the voter registration system 100. The processor 186 includes a government validation module 188 that can be a hardware module(s) and/or software module(s) (stored in memory 182 and/or executed in processor 186). The government validation module 188 can validate voter registration identification information associated with a valid voter (e.g., a user of a communication device 110) in a specific voting district by comparing the presented voter registration information with the corresponding voter information stored in, for example, the validation information database 184. Hence, the government validation module 188 can facilitate the process of a legitimate voter to get registered (external registration) and to receive a virtual voting registration number from the government voting agency server 160.

Note that the communication device 110, the enterprise device 130, the government voting agency server 160 and the government validation agency server 180 as shown in FIG. 1 are presented as an example only, and not a limitation. In other configurations, the voter registration system can include, for example, multiple communication devices 110 and/or different forms and numbers of government agencies or other voter authorities that can be part of a voter registration system.

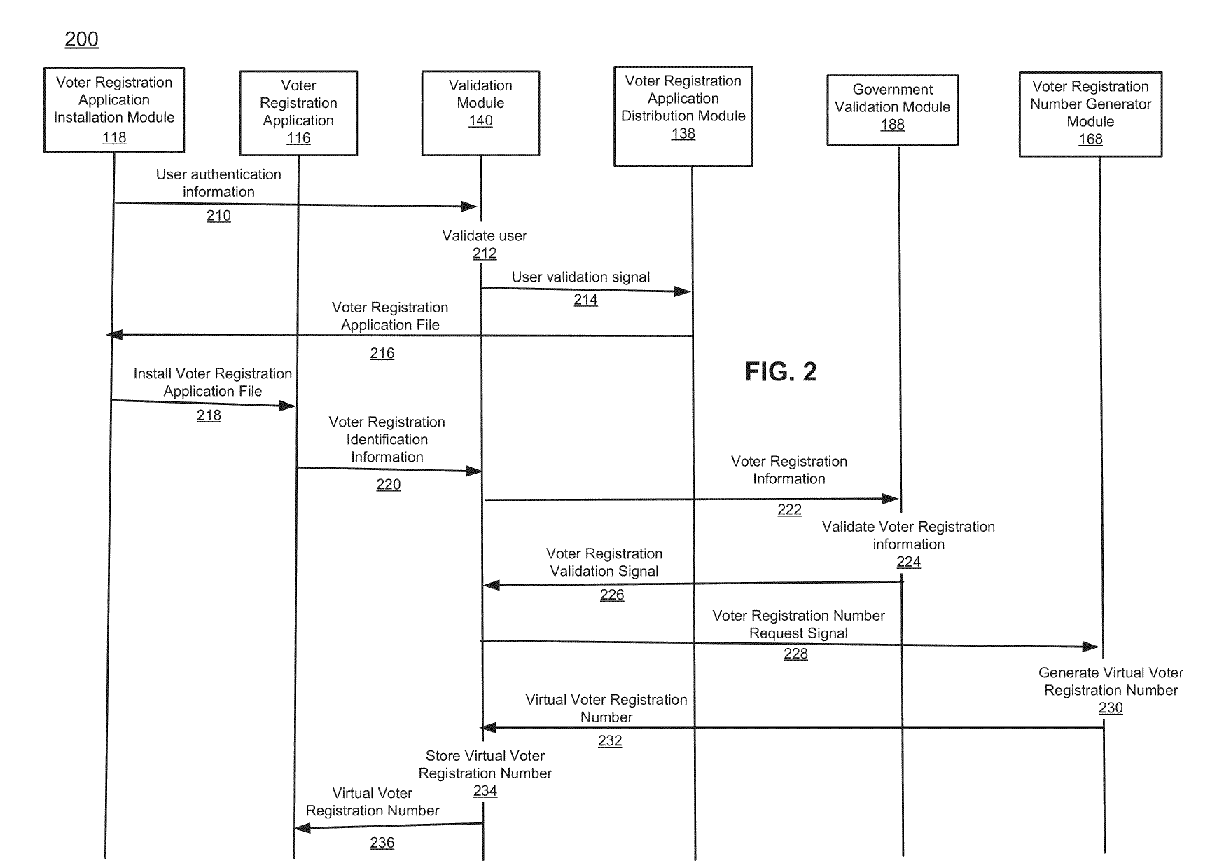

FIG. 2 is a message flow diagram illustrating a process for internal and/or external registration of voters and/or their communication devices, according to an embodiment. FIG. 2 is discussed in reference to the voter registration system 100 but can be used with different voter registration systems. In some embodiments, voters and/or their communication devices can be registered remotely. Similarly stated, the credentials and/or identification information described in further detail herein can be provided from communication devices to registration servers from the voters' homes or any other convenient location. In other embodiments, voters and/or their communication devices can be registered in person. Similarly stated, in some embodiments in order to validate the user and/or the user device, the credentials described herein can be and/or must be provided at a pre-designated voter registration site, such as a governmental office, library, post office, corporate office, a location designated by an advocacy group, etc.

At 210, the voter registration application installation module 118 (located in the communication device 110) can send user identification information to the validation module 140 (located in the enterprise server 130) via the network 150. Note that a user of a communication device 110 may or may not be a legitimate voter in a specific voting district and/or may or may not be (externally) registered to vote. Moreover, at 210, the user identification information can include an identifier or a set of identifiers unique to each user of the communication device 110. The identifier(s) associated with each user can be, a user login, a user password, a personal identification number (PIN), a driver's license number, a social security number, and/or the like.

The validation module 140 receives the user identification information from the voter registration application installation module 118 via the network 150 and validates the user, at 212. In some instances, the validation module 140 can validate the user by matching the user identification information to a specific entry in the voter registration database 134 stored in the memory 132 of the enterprise server 130. As described above, the voter registration database 134 can include identifiers (name, date of birth, gender, a user login, a user password, a personal identification number (PIN), residential address, driver's license number, and/or social security number) associated with the users of communication devices (e.g., in a specific voting district) that have installed a voter registration application 116. In other configurations, the voter registration database 134 can be stored in the memory of another device (e.g., server not shown in FIG. 2) operatively coupled to the network 150. In various configurations, the validation module 140 can validate the user using any suitable protocol.

Upon successful validation of the user, the validation module 140 can generate and/or define a user validation signal and send the user validation signal to the voter registration application distribution module 138, at 214. In some instances, for example, the user validation signal can include an encrypted form of a user identity number that has been assigned to the approved user. In other instances, user validation signal can include, for example, additional encrypted or unencrypted user credentials for added security measures, such as an authentication code operable to uniquely identify the communication device 110, such that the enterprise server 130 can validate signals received from the communication device 110 by the inclusion of the authentication code. In some embodiments, if the user is not successfully registered, the user can be prompted to seek a pre-authorized registration agent for manual registration. The registration agent can be provide an indication to authorize internal and/or external registration.

In response to receiving the user validation signal from the validation module 140, the voter registration application distribution module 138 can send a voter registration application file to the voter registration application installation module 118 via the network 150, at 216. As described above, in some instances, the voter registration application file can be an executable file. The voter registration application file can then be installed by the voter registration application installation module 118 in the communication device 110, at 218, to produce the voter registration application 116.

Upon successful installation of the voter registration file in the communication device 110, a voter (e.g., a user of the communication device) can take a photograph of the voter's driving license (or state-issued identification card) with the image acquisition module 120 (more generally, a “possession factor” associated with the voter), take a self-photograph of the voter's face (more generally, an “inherence factor” associated with the voter) with the image acquisition module 120, use the voter registration application 116 to enter the voter's drivers license number in a user interface (or other suitable output module or device) via an input module (e.g., a keyboard, mouse, touchscreen, etc.) (more generally, a “knowledge factor” associated with the voter), and optionally take a biometric scan associated with the voter (e.g., a fingerprint scan, a retinal scan, etc.) using the biometrics acquisition module 122. The “possession factor” can refer to an object or article that is unique to a voter and such an object or article is expected to be in possession of the voter only. Examples of “possession factor” can include a driver's license card, a government-issued identification card, a social security card, a passport, a voter registration card, and/or the like. The “inherence factor” can refer to a physical feature or attribute that is unique to the voter and can be used to identify the voter. Examples of “inherence factor” can include facial features, fingerprint patterns, retinal patterns, iris patterns, birth marks, voice print and/or the like. The “knowledge factor” can refer to information that is unique to a voter. Examples of “knowledge factor” can include a voter's driver's license number, government-issued identification number, passport number, social security number, employer identification number, date of birth, residential address, voter registration number, and/or the like. In some embodiments, such as in-person registration embodiments, a pre-authorized registration agent can supply or provide an indication of approval. For example, a government voter registration agent or registration agent of any suitable voter authority can verify the voter's credentials and provide an indication approving the user for registration.

The voter registration application 116 can combine the information obtained above (individually and/or collectively referred to as registration identification information) with an identifier associated with the communication device 110 (e.g., an internet protocol (IP) address, a media access control (MAC) address, an International Mobile Equipment Identity (IMEI) number, a Unique Device Identifier (UDID), etc.) into a signal that represents voter registration authentication information and send the voter registration authentication information to the validation module 140 via the network, at 220.

The validation module 140 can receive the voter registration identification information and can send at least a portion of the voter registration identification information (also referred to as voter registration information) to the government validation module 188, at 222. In some instances, the government validation module 188 can register the user to vote based on the voter registration identification information. Similarly stated, the user can be added to the government's database of registered voters based on signal 222. In other instances, the government validation module 188 can validate voter registration information associated with a voter in a specific voting district by comparing the presented voter registration information with the corresponding voter information stored in, for example, the validation information database 184, at 224. Upon successful registration and/or validation of the voter registration information, the government validation module 188 can send a voter registration validation signal to the validation module 140 via the network, at 226.

Upon receipt of the voter registration validation signal, the validation module 140 can send a voter registration number request signal to the voter registration number generation module 168, at 228. The voter registration number generation module 168 can generate and/or define a virtual voter registration number (also referred to herein as a virtual voter registration card, virtual voter registration number, and authentication code) by, for example, a random number generation method as described above in relation to FIG. 1, at 230. After successful generation of a virtual voter registration number, the voter registration number generation module 168 can store the newly-generated virtual voter registration number and the associated identifier of the voter in the voter registration number database 164. The voter registration number generation module 168 can send the virtual voter registration number to the validation module 140 via the network, at 232. In some instances, the authentication code can be suitable to uniquely identify the communication device 110 such that signals received containing the voter registration code can be uniquely associated with the communication device. Additionally, in some instances, the voter registration number generation module 168 can send the virtual voter registration number and the associated identifier of the voter to the government validation agency server 180 (not shown in FIG. 2). Furthermore, although the voter registration generator module 168 is shown as a module of the government voting agency server 160, in other instances, the enterprise server 130 can define the voter registration number, for example in response to receiving the voter registration identification information, at 220. In yet other instances, the communication device 110 can define the voter registration number and, upon receiving the voter registration identification information, at 220, or receiving the voter registration validation signal, at 226, the enterprise server 130 can associate the voter registration number with the communication device 110. Similarly, in other instances, the government voting agency server 130 may not define the voter registration number, but may associate the voter registration number with the communication device 110, for example, upon validating the voter registration information, at 224.

The validation module 140 can receive the virtual voter registration number and store the virtual voter registration number in, for example, the voter registration database 134, at 234. The validation module 140 can send the virtual voter registration number to the voter registration application 116 via the network, at 236. Upon receipt of the virtual voter registration number, the voter registration application 116 can store the virtual voter registration number in the memory 112 of the communication device 110 and/or a cache memory associated with the processor 114 of the communication device 110.

Thus at this point, the voter is registered and ready to vote in a subsequent election. FIGS. 3 and 4 discuss further the voting process after a voter has been registered.

FIG. 3 is a schematic illustration of a system for casting votes using communication devices, according to an embodiment. In some embodiments, votes can be cast remotely. Similarly stated, communication devices can be used to cast votes from the voters' homes or any other convenient location. In other embodiments, votes can be cast in person at a pre-designated polling place.

The system 300 shown in FIG. 3 includes a communication device 310, an enterprise server 330, a network 350, a government voting agency server 360, a government validation agency server 380, and a third party voting analysis server 390. The communication device 310, the enterprise server 330, the network 350, the government voting agency server 360, and the government validation agency server 380 are similar to those described in relation to FIG. 1 and their structure and functionality will not be discussed in detail in relation to FIG. 3.

The third party voting analysis server 390 can be, for example, a web server, an application server, a proxy server, a telnet server, a file transfer protocol (FTP) server, a mail server, a list server, a collaboration server and/or the like. The third party voting analysis server 390 can be, for example, a server associated with an independent voting monitoring agency that can be used to ascertain the validity of the votes cast and can perform various statistical analysis on the votes cast in a particular election (e.g., voter age group studies, voter demographic studies, voter lifestyle studies, voter occupation studies, exit poll studies, etc.). The third party voting analysis server 390 includes a memory 392 and a processor 394. The memory 392 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 392 can store instructions to cause the processor 394 to execute modules, processes and/or functions associated with the third party voting analysis server 390 and/or the voting system 300. The memory 392 can include a look-up table (not shown) that includes the results of past voting analysis studies. The processor 394 can be a general purpose processor, a Field Programmable Gate Array (FPGA), an Application Specific Integrated Circuit (ASIC), a Digital Signal Processor (DSP), and/or the like. The processor 394 can run and/or execute applications, modules, processes and/or functions associated with the third party voting analysis server 390 and/or the voting system 300. The processor 394 can include an analysis module 396 that can perform, for example, different statistical and analytical methods on voter related data in an election associated with a specific geographical area. Note that the different components of the voter registration system 100 and the voting system 300 can be the same, but have been shown separately in FIG. 1 and FIG. 3 for convenience of discussion.

FIG. 4 is a message flow diagram illustrating a process for voting using mobile communication devices, according to an embodiment. FIG. 4 is discussed in reference to the voting system 300 but can be used with other voting systems. After successful voter registration and issuance of a virtual voter registration number occurs for a legitimate voter, the registered voter can use the voter registration application 316 installed on a communication device 310 to cast a vote during a voting time period. At 410, the voter registration application 316 (located in the communication device 310) can send the voter identification information to the validation module 340 (located in the enterprise server 330) via the network. The voter identification information can be collected during the voting time period and after a registration period. Similarly stated, the voter identification information can be independent of the registration identification information discussed above. In this way, the voter identification information can be compared against the registration identification information to confirm (or validate) that the same user who is registered to vote is the person casting the vote.

The voter identification information can include, for example, the virtual voter registration number or a virtual voter registration card that includes a voter registration number (more generally, the “knowledge factor” associated with the voter), a photograph or the voter or a self-portrait image (more generally, the “inherence factor” associated with the voter), optionally additional biometric information associated with the voter as described above, and an identifier associated with the communication device 310 (e.g., an internet protocol (IP) address, a media access control (MAC) address, an International Mobile Equipment Identity (IMEI) number, a UDID, etc.). In some embodiments, such as in-person voting embodiments, the voter identification information can include an approval of a pre-authorized voting agent, such as a polling place worker. The voter identification information can also include the authentication code, which can uniquely identify the communication device 310. Thus, the voter identification information can be operable to uniquely identify and/or validate the voter and the communication device 310.

In some instances, one voter may be associated with multiple authentication codes. For example, a voter may (internally) register using multiple devices, each device uniquely associated with an authentication code. In a one-person-one-vote election, once voter identification information for that voter including one authentication code is received, other authentication codes associated with that user can be revoked such that they cannot be used to cast additional ballots. In elections where a voter is allowed to vote more than once (e.g., a one-device-one-vote election, an election where multiple votes from a single device and/or a single user are allowed, etc.), other authentication codes associated with that user and/or other devices associated with that user may not be revoked. For example, the user may be permitted to vote multiple times on a single device using the authentication code associated with that device. Alternatively, in some instances, if a voter attempts to register more than once and/or with more than one device, registration can be denied (e.g., an authentication code may not be defined), and/or prior authentication codes can be revoked during the registration process described above.

The validation module 340 receives the voter identification information from the voter registration application 316 via the network and validates the voter, at 412. In some instances, the validation module 340 can validate the voter by matching the voter identification information to a specific entry in the voter registration database 334 stored in the memory 332 of the enterprise server 330. In other instances, the validation module 340 can validate the voter by matching the voter identification information to a specific entry in the voter registration database 334 stored in the memory 332 of the enterprise server 330 and/or the voter registration number database 364 of the government voting agency server 360 and/or the validation information database 384 of the government validation agency server 380. Similarly stated, if the voter identification information matches the registration identification information received during the registration process, the voter can be validated. In some instances, the voter can be validated if the voter identification information matches the registration identification information within a pre-defined identification criteria. For instance, biometric data, images of documents, and so forth captured at different times (e.g., the registration time period and the voting time period) may not exactly match. The voter can be validated if the voter identification information matches the registration identification information within a pre-defined limit as calculated by, for example, image matching or biometric matching algorithms. In some instances, the voter identification information matches the voter registration information if the authentication code exactly matches the authentication code received or assigned during the registration process. For example, the authentication code can be an alpha-numeric or other suitable identifier that can be reproduced exactly, such that an exact match can be required to validate the communication device 310. In other instances, fuzzy matching of the authentication code can be used during validation.

As described above, the voter registration database 334 can include identifiers (name, date of birth, gender, a user login, a user password, a personal identification number (PIN), residential address, driver's license number, and/or social security number) associated with the different users (e.g., in a specific voting district) that have obtained a voter registration application 316 from the enterprise. As described above, the voter registration number database 364 includes identifiers (name, date of birth, gender, residential address, and/or driver's license number) associated with the different voters in, for example, a state, a county, or a specific voting district have been issued with a valid voter registration number (i.e., either a virtual voter registration number and/or a paper-application-based voter registration number). As described above, the validation information database 384 includes identifiers (name, date of birth, gender, residential address, driver's license number, voter registration number, social security number, and/or passport number) associated with a population (i.e., both legitimate voters and non-voters such as underage US citizens, felons, permanent resident aliens, non-permanent resident aliens, etc.) in, for example, a state, a county, or a specific voting district.

Upon successful validation of a voter, the validation module 340 sends a voter validation signal to the voter registration number generator module 368 via the network, at 414. The voter registration number generation module 368 can generate and/or define a virtual voter ballot, at 416. The virtual voter ballot can also be associated with a unique identifier (e.g., the authentication code) for added security purposes. The voter registration number generation module 368 can send the virtual voter ballot to the validation module 340 via the network, at 418. Subsequently or concurrently, the voter registration number generation module 368 can also send the virtual voter ballot to the voter registration application 316 via the network, at 420. In some embodiments, if the voter is not successfully validated, for example, if the communication device repeatedly (e.g., more than a threshold number of times) sends voter identification information that does not match the registration identification information, the validation module 388 can revoke the authentication code such that that authentication code can no longer be used to cast a ballot. In some embodiments, if the voter is not successfully validated, the voter can be prompted to seek a poll worker for manual verification. If the poll worker validates the user, the poll worker can supply an indication of approval such that the voter can be validated.

A legitimate and registered voter (e.g., user of the communication device 310) can use the voter registration application 316 to review and fill out (or complete) the virtual voter ballot, at 422. Completing the virtual voter ballot can include selecting an answer to at least one question on the ballot such as, for example, entering the voter registration number, selecting the name of a candidate for state legislator and/or a candidate for state governor and/or a candidate for the US House of Representatives and/or a candidate for the US Senate and/or a candidate for US president and/or a specific ballot initiative (e.g., legalization of same sex marriage in a state, limiting access to abortion services in a state, etc.), answering a question for an opinion poll, providing feedback on an advocacy group initiative, etc.

The voter registration application 316 sends the completed virtual voter ballot (e.g., the answer to the at least one question) to the validation module 340 via the network, at 424. Subsequently or concurrently, the voter registration application 316 sends the completed virtual voter ballot to the voter registration number generator module 368 via the network, at 426. Subsequently or concurrently, the voter registration application 316 sends the completed virtual voter ballot to the analysis module 398 via the network, at 428.

Note that in some instances, the completed voter ballot is sent by the voter registration application 316 to only the validation module 340 (and not the voter registration number generator module 368, and/or the analysis module 396). In such instances, the validation module 340 can periodically or substantially periodically send copies of completed virtual voter ballots to the voter registration number generator module 368, and/or the analysis module 396. Note that in yet other instances, the completed voter ballots sent by the voter registration application 316 to the validation module 340, and the voter registration number generator module 368, and the analysis module 396 can only include the virtual voter ballot identifier and the information associated with the votes cast. In such instances, all identifiers associated with a voter can be deleted by the voter registration application 316 to establish non-traceable privacy of the voter.

In some instances, after all the votes for a specific voting district in an election has been cast, the enterprise server 330 can aggregate and display the results of the voting if the data files for votes cast is identically recorded in the validation module 340, and the voter registration number generator module 368, and the analysis module 396. If the data files for votes are not identically recorded in the validation module 340 and the voter registration number generator module 368 and the analysis module 396, a signal indicating voting fraud can be generated by the validation module 340. Hence, periodic or substantially periodic transmission of completed virtual voter ballots to the three modules can help detect voting irregularities and thus can assist in implementing accurate methods to overcome such voting irregularities.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. For example, although some embodiments are shown and described as including or relating to government validation, government registration, and so forth, it should be understood that validation, registration, etc. can be performed by any suitable voter authority. For another example, although some embodiments are described as related to casting a single vote, in other embodiments, for example, during a corporate election, a voter (e.g., a shareholder) may be authorized to cast more than one vote. In such an instance, devices and modules described herein can be operable to enable the voter to divide his or her votes in any suitable manner. For example, a user interface of the voter registration application 316 can allow the voter to allocate votes across any number of options when the virtual voter ballot is completed, at 422.

For another example, where devices are shown or described as containing specific modules, it should be understood that, unless clearly indicated otherwise, devices can include additional or fewer modules. Furthermore, while certain devices and/or modules are described as performing specific functions, it should be understood that any functions described herein can be performed by any suitable device and/or module. For example, different modules are described as performing different functions associated with registration for ease of discussion (e.g., the validation module 140, the voter registration application distribution module 138, the voter registration number generator module 168, and the government registration module 188); it should be understood that any suitable module located in any device can perform any suitable registration function, and may be referred to generally as a registration module. Similarly, different modules are described as performing different functions associated with voting for ease of discussion (e.g., the voter registration application 316, the voter registration installation module 318, the voter registration installation module 318, the voter registration application distribution module 338, the validation module 340, the voter registration number generator module 368, the government validation module 388, and the analysis module 396); it should be understood that any suitable module located in any device can perform any suitable voting function and may be referred to generally as a vote or voting module. Similarly, different modules are described as performing different functions associated with ballots, such as generating ballots, sending ballots, receiving ballots, completing ballots, tallying ballots, etc.; it should be understood that any suitable module located in any device can perform any suitable balloting function and may be referred to generally as a ballot module. Similarly, any suitable module located in any device can perform any suitable function associated with validating a user and/or user device and can be referred to generally as a validation module, and any module suitable for sending and/or receiving signals, for example, over a network, can be referred to generally as a network module.

For another example, although some embodiments describe a validation module of an enterprise server or voter authority validation agency validating a voter, in other embodiments, a communication device can validate a voter in addition to or as an alternative to the enterprise server and/or voter authority validating the voter. For example, the communication device can store registration identification information associated with the voter during a registration period. During the voting period, the communication device can compare voter identification information (e.g., an inherence factor, a possession factor, a knowledge factor, etc.) against the registration identification information. If the identification information received during the voting period does not match the information received during the registration period, it can be an indication that a different (unregistered) user is attempting to use the communication device to cast a ballot. The communication device can disallow such identification information from being sent to the enterprise server and/or can revoke or delete an authentication key received during registration such that the communication device cannot be used to cast a ballot in the future without reregistering the device with the enterprise server and/or a voter authority.

Although various modules in the different devices are shown to be located in the processors of the device, they can also be located/stored in the memory of the device (e.g., software modules) and can be accessed and executed by the processors.

Where methods described above indicate certain events occurring in certain order, the ordering of certain events may be modified, additional events can occur between events, and/or certain events can be omitted, uncles clearly indicated otherwise. Additionally, certain of the events may be performed concurrently in a parallel process when possible, as well as performed sequentially as described above. For example, although some embodiments described herein describe registration and voting periods occurring sequentially, in other embodiments, voting and registration can occur concurrently or in overlapping time periods.

What is claimed is:

1. An apparatus, comprising:
a registration module implemented in at least one of a processor or a memory, the registration module configured to:
receive a request for voter registration from a user device, the request for registration including first identification information having at least two of (1) a possession factor, (2) a knowledge factor, (3) an inherence factor, or (4) an indication of approval from a pre-authorized registration agent,
validate a user of the user device by verifying the first identification information against a voter-authority database, and
receive a first authentication code from the voter-authority database upon validating the user; and
a vote module operably coupled to the registration module, the vote module configured to:
receive a signal representing a vote from the user device, including (1) a selection on a question of a ballot, (2) second identification information, and (3) a second authentication code, and
tally the vote when the second identification information satisfies a pre-defined identification criteria based on a comparison to the first identification information and the second authentication code exactly matches the first authentication code.

2. The apparatus of claim 1, wherein the registration module is configured to send the ballot and the first authentication code to the user device in response to verifying the first identification information against the government database.

3. The apparatus of claim 1, wherein the vote module is configured to send a signal to the user device instructing the user to contact a poll worker based on at least one of (1) the second identification not satisfying the pre-defined identification criteria or (2) the second authentication code not exactly matching the first authentication code.

4. The apparatus of claim 1, wherein the vote module is configured to revoke the first authentication code such that the vote module will not tally a vote associated with the first authentication code in response to the vote module receiving more than a threshold number of signals including the second identification information not satisfying the pre-defined identification criteria .

5. The apparatus of claim 1, further comprising:
an image capture module operably coupled to the registration module, the image capture module configured to capture at least one of the possession factor or the inherence factor.

6. The apparatus of claim 1, wherein the user device is a mobile communication device.

7. The apparatus of claim 1, wherein the authentication code is effective to uniquely identify the user device.

8. The apparatus of claim 1, wherein the first identification information and the second identification information are each effective to uniquely identify the user.

9. The apparatus of claim 1, wherein:
the first identification information includes the possession factor and the knowledge factor; and
the second identification information includes the possession factor and the knowledge factor.

10. The apparatus of claim 1, further comprising:
an authentication code generation module operably coupled to the registration module, the authentication code generation module configured to assign a unique authentication code to the user device in response to the first identification information matching the voter-authority database.

11. The apparatus of claim 1, wherein the voter-authority database is a government database of authorized voters in at least one of a district or a state.

12. An apparatus, comprising:
a validation module configured to obtain at least one of a possession factor or an inherence factor during a first time period;
a network module operably coupled to the validation module, the network module configured to send first identification information to a first server, the first identification information including at least two of (1) the possession factor obtained during the first time period, (2) a knowledge factor, (3) the inherence factor obtained at during the first time period, or (4) an indication of approval from a pre-authorized registration agent;
a ballot module implemented in at least one of a processor or a memory, the ballot module operably coupled to the network module and configured to:
receive a representation of a ballot and an authentication code,
cause the validation module to obtain the at least one of the possession factor or the inherence factor during a second time period, a beginning of the second time period occurring after an ending of the first time period, and
send (1) a representation of a selection of a question on the ballot, (2) the authentication code, and (3) the at least one of the possession factor or the inherence factor obtained during the second time period to a second server such that the second server tallies the selection of the question on the ballot when the at least one of the possession factor or the inherency factor obtained during the second time period satisfies a pre-defined identification criteria based on a comparison to second identification information, the second identification information stored in a voter-authority database.

13. The apparatus of claim 12, wherein:
the authentication code is effective to uniquely identify the user device; and
the first identification information and the second identification information are each effective to uniquely identify the user.

14. The apparatus of claim 12, wherein the first identification information is effective to identify the user in accordance with government voter registration requirements.

15. The apparatus of claim 12, wherein the second identification information is effective to identify the user in accordance with government voter identification requirements.

16. The apparatus of claim 12, wherein:
the authentication module includes a biometric acquisition module;
each of the inherence factor obtained during the first time period and the inherence factor obtained during the second time period is a biometric factor;
the first identification information includes the inherence factor obtained during the first time period; and
the ballot module is configured to send the inherence factor obtained during the second time period.

17. The apparatus of claim 12, wherein the first identification information includes the possession factor obtained during the first time period, the inherence factor obtained during the first time period, and the indication of approval from the pre-authorized registration agent such that the identification information represents an in-person voter registration.

18. The apparatus of claim 12, wherein the ballot module is configured to send the representation of the selection of the question on the ballot from a home of the user.

19. The apparatus of claim 12, wherein the user device is a mobile communication device owned by the user.

20. The apparatus of claim 19, wherein the ballot module is configured to:
cause the validation module to capture an indication of approval from a governmental polling place official during the second time period; and
send the representation of the selection of the question on the ballot and the indication of approval from the governmental polling place official during the second time period such that the representation of selection on the question on the ballot represents an in-person, polling place selection of the question on the ballot.

21. The apparatus of claim 12, further comprising an input/output module operatively coupled to the validation module, the input/output module configured to prompt the user for and receive an indication of at least one of the possession factor obtained during the first time period or the knowledge factor, the identification information including the at least one of the possession factor obtained during the first time period or the knowledge factor received from the input/output module.

22. A non-transitory processor readable medium storing code representing instructions to be executed by a processor, the code comprising code to cause the processor to:
receive a signal representing a request to register a user device and including first identification information collected during a first time period having at least two of (1) a possession factor, (2) a knowledge factor, (3) an inherence factor, or (4) an indication of approval from a pre-authorized registration agent;
validate a user of the user device and associating the user device with a first voter registration number based on the first identification information satisfying a first pre-defined identification criteria based on a comparison to an entry in a voter registration database;
send a signal including a representation of a ballot to the user device in response to validating the user of the user device;
receive a signal representing a selection of a question on the ballot including a second voter registration number and second identification information having at least one of the possession factor or the inherence factor, the second identification information collected during a second time period, a beginning of the second time period occurring after an end of the first time period; and
tally the selection of the question on the ballot when the second identification information satisfies a second pre-defined identification criteria based on a comparison to the first identification information and the second voter registration number exactly matches the first voter registration number.

23. The non-transitory processor readable medium of claim 22, wherein the first identification information satisfies a government-defined requirement for voter registration.

24. The non-transitory processor readable medium of claim 22, wherein the first identification information includes the possession factor, the possession factor indicating that the user possesses a government-issued identity document.

25. The non-transitory processor readable medium of claim 22, wherein the second identification factor includes the inherence factor, the inherence factor including an indication of a biometric feature of the user.

26. The non-transitory processor readable medium of claim 22, wherein:
the first identification information includes the indication of approval from the pre-authorized registration agent such that the signal representing the request to register the user device is a signal representing an in-person voter registration at a voter registration site; and
the signal representing the selection of the question on the ballot represents the selection of the question on the ballot at a site that is not a pre-designated site.

27. The non-transitory processor readable medium of claim 22, wherein:
the signal representing the request to register the user device is a signal representing remote voter registration at a site that is not a pre-designated site; and
the second identification information includes an indication of approval from a pre-authorized polling agent such that the signal representing the selection of the question on the ballot represents an in-person selection of the question on the ballot at a pre-designated polling place.
